(19) United States
(12) Patent Application Publication
(10) Pub. No.: US 2009/0200122 A1
(43) Pub. Date: Aug. 13, 2009

(54) SLIDING ARRANGEMENT FOR A DISK BRAKE

(76) Inventors: Lars Bagge, Göteborg (SE); Claes Edgren, Mölnlycke (SE)

Correspondence Address: WRB-IP LLP, 1217 KING STREET, ALEXANDRIA, VA, 22314, US

(21) Appl. No.: 12/295,731

(22) PCT Filed: Apr. 25, 2007
(86) PCT No.: PCT/SE07/00399

§ 371 Date: Oct. 2, 2008

(30) Foreign Application Priority Data
Apr. 25, 2006 (SE) 0600923-7

(51) Int. Cl. F16D 55/227; F16C 33/04

(52) U.S. Cl. 188/73.45; 384/192

(57) ABSTRACT

A sliding arrangement for a disk brake includes a caliper adapted to engage a brake disk, and a first and a second support bearing for fixing the caliper to a brake support of the vehicle so that the caliper is axially slideable relative to the brake disk, where the first support bearing includes a first guide pin and a first guide bushing and the second support bearing includes a second guide pin and a second guide bushing, where the first guide pin and guide bushing have substantially no play between their sliding surfaces and the second guide pin and guide bushing have a play between their sliding surfaces, wherein the second guide bushing include an inner and an outer annular metal member with an annular member of resilient material therebetween, and wherein the bushing is mounted such that the center of the bushing is offset to the center of the guide pin. Hereby, brake noise created by vibrations when the brake is inactive is eliminated.

### BACKGROUND AND SUMMARY

The present invention relates to a sliding arrangement for a disk brake for a vehicle, such as a truck, a bus or the like, comprising a caliper adapted to engage a brake disk and two support bearings for fixing said caliper to a brake support of the vehicle so that the caliper is axially slidable relative to the brake disk, where a first support bearing includes a first guide pin and a first guide bushing having substantially no play and a second support bearing includes a second guide pin and a second guide bushing having a play.

A disk brake of such kind is known from WO 03/025413 A1. A sliding disk brake includes a fixed and a floating bearing where the floating bearing includes a guide bushing having an inner opening with an oval cross-section in which a circular bearing bolt is inserted. The idea is to allow for movements of the bearing bolt in only one direction in the guide bushing. The purpose is to take up production tolerances and allow for movements of the caliper during braking of the vehicle, and at the same time remove brake noise such as rattle. This solution may compensate for some tolerances when producing the brake, i.e. when the brake is new, but it will not be able to compensate for the tolerances caused by wear. Thus, a certain play and some rattle noise will be unavoidable, both when the brake is new and especially when the brake has been used. Similar bushings with different hole dimensions and shapes are known in the art.

However, the drawback of the known type of disk brake is that the brake caliper is loosely mounted when the disk brake is inactive. This results in a rattling noise from the disk brakes of a vehicle in particular when driven on an uneven surface where vibrations are transferred to the disk brake caliper, whereby a knocking noise is produced in the direction perpendicular to the two guide sleeves of the sliding disk brake due to the tolerances of the floating bearing.

The problem faced by all brake manufacturers is to allow for the caliper to slide freely on two guide pins in order to provide for a floating caliper. The play between the guide pin and the bushing should therefore be as small as possible to avoid noise. At the same time, production tolerances must be compensated for in order to avoid the caliper to jam on the guide pins. Also, the caliper is not allowed to tilt which could cause further jamming. Some play is therefore necessary. One common solution is to use asymmetric mounting means when mounting the caliper. These asymmetric mounting means are adjusted to compensate for the tolerances during mounting of the brake. Although these mounting means may work well when the brake is new, they will not compensate for wear and also not for dynamic loads caused by the braking action. JP 55054732, JP 58061340 and GB 2311107 describe such disk brakes.

Further examples of providing a noise-free disk brake with a sliding caliper are shown in e.g. DE 4411700, DE 2514383, JP 2002/276699, JP 2000/027904 and JP 11117959. Also these solutions may work when the disk brake is new, but they will not compensate for wear and also not for dynamic loads caused by the braking action.

This results in a rattling noise from the disk brakes of a vehicle in particular when driven on an uneven surface where vibrations are transferred to the disk brake caliper, whereby a knocking noise is produced in the direction perpendicular to the two guide sleeves of the sliding disk brake due to the tolerances of the floating bearing. This rattling noise is produced when the disk brakes are inactive and can be heard in the cabin of the vehicle, in particular in a bus with the engine in the rear. This problem is mostly noticeable on heavy vehicles, such as trucks or buses, since the mass of the parts in a brake are greater than on a passenger car. On this background it is desirable to provide a sliding arrangement for a disk brake of the initially mentioned kind where the noise during the inactive brake state is reduced or even eliminated.

According to an aspect of the present invention, a sliding arrangement for a disk brake is provided wherein a second guide bushing comprises an inner and an outer annular metal member with an annular member of resilient material therebetween, and wherein the bushing is mounted such that the center of the bushing is offset to the center of the guide pin.

By an aspect of the invention, the advantages of a disk brake with a floating caliper are maintained, but the noise in the inactive brake state is eliminated. A disk brake according to the invention has the desired ability to provide position tolerances between the two guide pins and at the same time to eliminate the knocking noise caused by the play between a guide pin and a bushing. Further, the inventive sliding arrangement can make up for tolerances caused by wear on the guide pin and/or bushing.

In a first embodiment, the bushing is mounted in such a manner that the second guide pin is asymmetrically mounted with regards to the second bushing, i.e. the center of the guide pin is offset to the center of the bushing. Accordingly, the bushing will be compressed or pre-tensioned in a direction passing through the two guide pins. Moreover, the bushing is provided with an inner diameter that is larger than the diameter of the guide pin. Hereby, the second guide pin center is slightly offset relative to the center of the bushing so that a force is created between the guide pin and the bushing wall. The resilient material is dimensioned to take up all production tolerances and also to allow for a predetermined minimum pre-tensioning of the bushing for all tolerance cases. Sliding forces in the axial direction of the guide pins must be balanced with appropriate friction between the guide pin and the bushing material. When forces on the caliper act in perpendicular direction, the contact surface of the guide pin will slide or roll in a radial direction in the bushing instead of bouncing from side to side. Due to the pre-tensioning, the contact surface of the guide pin will be in constant contact with the bushing, thus the noise will be eliminated.

Preferably, the annular outer member of the bushing is a steel ring and the resilient material is bonded to the inner side of the outer ring. Moreover, the annular inner member is preferably made of a low friction material, such as brass, bonded to the resilient material. The resilient material is preferably rubber or plastic.

In a further embodiment of the invention, the bushing displays a first compression resistance in a radial direction of the bushing corresponding to a plane defined by the two guide pins, and a second compression resistance in a radial direction of the bushing perpendicular to said guide pin plane, wherein the first compression resistance is lower than the second compression resistance. Preferably, the lower first compression resistance is provided by one or more cavities in at least one section of the annular resilient material. Hereby, an advantageous difference in stiffness in different directions of the bushing is obtainable in a simple manner. The resilient material layer is preferably relative thick so that a substantial difference in the compression resistances in the two directions can be provided.

In a second aspect of the invention, there is also provided a guide bushing for a disk brake caliper in a vehicle, such as a truck, a bus or the like, where said guide bushing comprises an inner and outer annular metal member with an annular member of resilient material therebetween, said resilient material having different compression resistance in two different radial directions of the resilient guide bush.

### BRIEF DESCRIPTION OF THE DRAWINGS

In the following, the invention is described in more detail with reference to the accompanying drawings, in which

FIG. 1 is a partial view of a disk brake according to the invention;

FIG. 2 is a detailed sectional exploded view of a support bearing according to the invention, and

FIG. 3 is a detailed view of a support bearing mounted in a caliper according to the invention.

### DETAILED DESCRIPTION

FIG. 1 shows a caliper 2 of a disk brake for a utility vehicle, in particular a truck or a bus. The caliper 2 straddles a brake disk (not shown) and the caliper 2 is displaceably fastened to the brake support (not shown) of the vehicle in a known manner.

The caliper 2 is axially displaceable along two guide pins. The caliper 2 is slidably mounted over a first support bearing 3 including the first guide pin 6 and a second support bearing 4 including the second guide pin 7. Hereby, the caliper 2 is slidably mounted on the two parallel placed guide pins 6, 7 so that the caliper 2 can slide between a first position where the brake is activated and a second position where the brake is inactive, i.e. the brake pads does not exert any pressure on the brake disk. The caliper will also slide on the guide pins to compensate for wear of the brake pads.

The first bearing 3 includes a first bushing 15 which is pressed into the bore 16 of the caliper 2. The bushing 15 is an annular metal member pressed into the hole and is used as a liner in the hole. The purpose is to achieve a low friction and a tight fitting with substantially no play to the guide pin. The bushing is preferably made in a low-friction material such as a brass composition. Such a bushing is well-known in the art and is not described further. The guide pin 6 extends through the bushing 15 and is fixed to the brake support (not shown). The second support bearing 4 includes a bushing 8 which is pressed into the bore 9 of the caliper 2. The guide pin 7 extends through the bushing 8 and is fixed to the brake support (not shown).

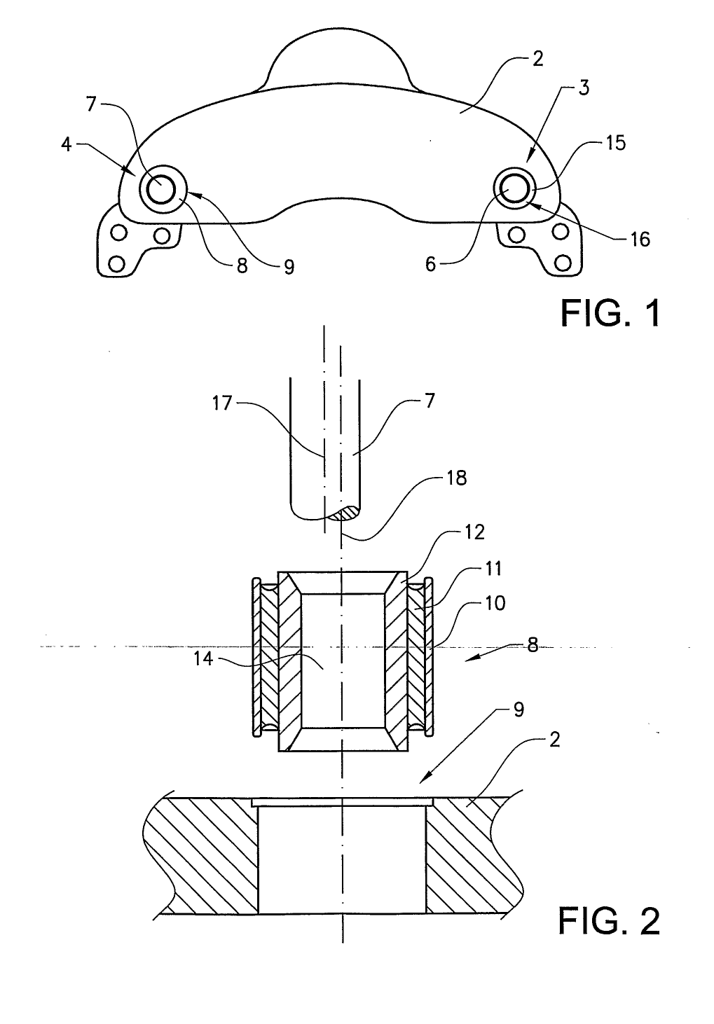

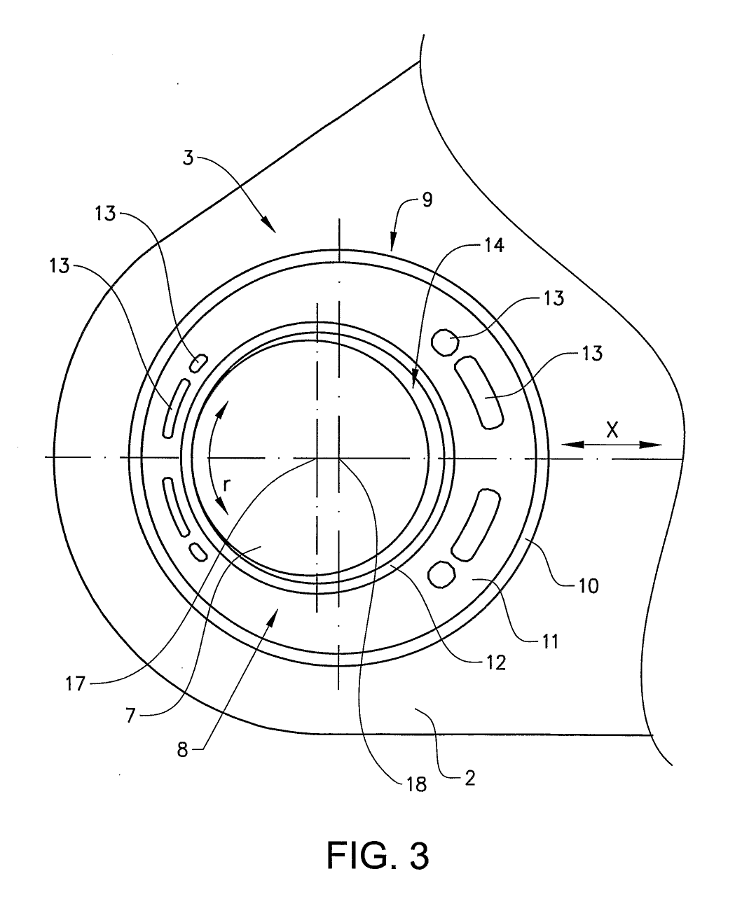

With reference to FIGS. 2 and 3, the invention is shown in more detail. The second guide pin 7 is mounted extending through a guide bushing 8 which is mounted in a bore 9 in the caliper 2. The bushing 8 comprises an outer cylindrical member 10

which preferably has circular cross-sectional shape and is pressed into the correspondingly sized bore 9 of the caliper 2. The bushing 8 further comprises an inner member 12, which also has a circular cross-sectional shape. Between the outer ring 10 and the inner ring 12 a resilient material 11, preferably rubber or plastic, is provided.

The outer member 10 of the bushing 8 is provided with an external diameter which corresponds with the diameter of the bore 9 of the caliper 2 in such a manner that the bushing is mounted with a press fitting in the bore 9 of the caliper 2. The inner member 12 has an inner circular opening 14 with an inner diameter which is larger than the diameter of the guide pin 7. The bushing 8 is mounted in the caliper 2 in such a way that the center 18 of the bushing 8 is offset to the center 17 of the guide pin 7 so that a force is created between the guide pin and the bushing wall. This mounting will pretension the second bearing such that a position tolerances between the two guide pins are achieved. The guide pin 7 will, due to the pretension, bear at the bushing 8 constantly. This pretension will thus eliminate the knocking noise caused by the play between the guide pin and the bushing of the prior art. The pretension will also compensate for tolerances caused by wear on the guide pin and/or bushing. The resilient material is dimensioned to take up all production tolerances and also to allow for a predetermined minimum pre-tensioning of the bushing for all tolerance cases.

Since the caliper is mounted so that the two bearings are prestressed, the guide pin 7 will not knock against the inner member 12 of the bush 8 when the brake is inactive, but will slide or roll against the inner member 12 in a radial manner along the arrow denoted r. The mounting of the second guide pin 7 in a prestressed manner ensures a constant contact between the guide pin 7 and the contact surface of the inner member 12 of the bush 8 due to the compression of the resilient material 11 of the guide bush 8.

As shown in FIG. 3, the resilient rubber material is provided with cavities 13, which preferably are through-going holes so they are visible for the worker who is assembling the brake or to a mounting tool. These cavities 13 are provided in two sectors that are situated opposite each other on each side of the inner ring 12. These two sectors of cavities 13 are provided such that the bushing 8 has a first compression resistance in a radial direction of the bush corresponding to a plane defined by the two guide pins 6, 7 when the bushing is mounted in the caliper. This plane is denoted with the arrow x. The bushing 8 has a second compression resistance in a direction perpendicular to said guide pin plane, wherein the first compression resistance is lower than the second compression resistance. The different compression resistances can also be obtained by using different materials for different directions. Accordingly, as shown in FIG. 3, the resilient material on one side of the bushing 8 is slightly compressed and the other side of the bushing is slightly expanded by the offset mounting of the guide pin and the bushing.

Another advantage of the invention is that the pre-tensioning of the bushing 8 with regards to the second guide pin will also compensate for wear in the guide pin 7 and the inner member of the bushing 8. Also wear in the first guide pin 6 and the bushing 15 will be compensated for. Normally, the guide pins are made of hard steel and the bushings of a low-friction material, e.g. a brass composition that has a lower wear resistance than the guide pin. The invention thus allows for the use of a bushing material with an even k>wer friction, and a possible lower wear resistance, in order to improve the performance of the brake further, since the wear will be compensated for.

In the first embodiment of the invention, a guide bushing with a circular cross-section has been described. In a further embodiment, it would also be possible to use a guide bushing with an oval cross-section or a guide bushing with a circular outer member and an oval inner member. It would also be possible to attach the resilient material directly to the caliper, thus the circular outer member would be superfluous.

Above, the invention is described with reference to a preferred embodiment. However, it is realised that other embodiments may be provided without departing from the scope of the invention as defined in the accompanying claims. As an example, the resilient material may be provided in other materials than rubber and the material may be provided with different densities in sectors instead of—or as a supplement to—the cavities.

1. A sliding arrangement for a disk brake, comprising:
a caliper adapted to engage a brake disk;
a first and a second support bearing for fixing the caliper to a brake support of the vehicle so that the caliper is axially slideable relative to the brake disk, where the first support bearing includes a first guide pin and a first guide bushing and the second support bearing includes a second guide pin and a second guide bushing, where the first guide pin and guide bushing have substantially no play between their sliding surfaces and the second guide pin and guide bushing have a play between their sliding surfaces;
wherein the second guide bushing comprises an inner and an outer annular metal member with an annular member of resilient material therebetween, and that the bushing is mounted such that the center of the bushing is offset to the center of the guide pin.

2. A sliding arrangement according to claim 1, wherein the second guide bushing is provided with a first compression resistance in a first radial direction and a second compression resistance in a second radial direction of the bushing.

3. A sliding arrangement according to claim 2, wherein the first radial direction and the second radial direction are perpendicular to each other.

4. A sliding arrangement according to claim 2, wherein the first radial direction of the bushing corresponds to a plane defined by the two guide pins.

5. A sliding arrangement according to claim 2, wherein the first compression resistance is lower than the second compression resistance.

6. A sliding arrangement according to claim 5, wherein the lower first compression resistance is provided by one or more cavities in at least one section of the annular resilient material.

7. A sliding arrangement according to claim 1, wherein the resilient material is bonded to the inner and the outer annular metal member.

8. A sliding arrangement according to claim 1, wherein the annular inner member is made of a low friction material, such as brass or a brass composition.

9. A sliding arrangement according to claim 1, wherein the outer annular metal member is comprised in the caliper, such that the resilient material is bonded directly to the caliper.

10. A guide bushing for a sliding arrangement in a disk brake, wherein the guide bushing comprises an inner and an outer annular metal member with an annular member of resilient material therebetween, the bushing being provided with a first compression resistance in a first radial direction and a second compression resistance in a second radial direction of the bushing.

11. A guide bushing according to claim 10, wherein the lower compression resistance is provided by one or more cavities in at least one section of the annular resilient material.

12. A guide bushing according to claim 10, wherein the annular outer member is a steel ring, the annular inner member is made of a low friction material and the resilient material is bonded to the outer and inner member.

13. A disk brake for a vehicle, comprising a sliding arrangement according to claim 1.

14. A vehicle comprising a plurality of disk brakes according to claim 13.
